(19) United States
(12) Patent Application Publication
(10) Pub. No.: US 2024/0239969 A1
(43) Pub. Date: Jul. 18, 2024

(54) SURFACE MIGRATION OF INORGANIC PARTICLES TO PRODUCE FUNCTIONAL PLASTICS

(71) Applicant: NSC - NANO SONO COOPERATION LTD, Yokneam Illit (IL)

(72) Inventors: Rajashekharayya A. Sanguramath, Yokneam Illit (IL); Nadav Raz, Yokneam Illit (IL); David Binder, Yokneam Illit (IL)

(73) Assignee: NSC - NANO SONO COOPERATION LTD, Yokneam Illit (IL)

(21) Appl. No.: 18/504,210

(22) Filed: Nov. 8, 2023

Related U.S. Application Data
(60) Provisional application No. 63/382,735, filed on Nov. 8, 2022.

(51) Int. Cl. C08J 3/22; C08J 3/205; C08L 23/06; C08L 23/12

(52) U.S. Cl. CPC C08J 3/226; C08J 3/2053; C08L 23/06; C08L 23/12; C08J 2323/06; C08J 2323/12; C08J 2483/04; C08L 2207/324; C08L 2310/00

(57) ABSTRACT

Described herein is a process to prepare plastic masterbatches, compounds, and compositions thereof composed of at least one plastic matrix, at least one low density solvent or low viscosity solvent, optionally at least one dispersant, and at least one type of inorganic particles. The process described herein improves and optimizes migration mechanism of particles to the surface of the compounded plastic composition and reduces the material lost, by first dispersing the inorganic particles in low density solvent or low viscosity solvent followed by extrusion in plastics matrices.

### CROSS-REFERENCE TO RELATED APPLICATIONS

Benefit is claimed to U.S. Provisional Patent Application No. 63/382,735, filed Nov. 8, 2022, the contents of which are incorporated by reference herein in their entirety.

### FIELD

This disclosure relates to a process to prepare plastic masterbatches or compounded materials thereof which improves and optimizes the migration mechanism of nanoparticles to the surface of materials prepared from the masterbatches or compounds, and reduces the material lost.

### BACKGROUND

Plastics and polymers are the most commonly used materials in countless everyday surfaces and applications. However, when contaminated with undesirable microorganisms, these materials can pose a heightened risk of disease transmission, food spoilage, and various other health-related complications. Despite stringent cleaning protocols in place across healthcare, food, travel, and hospitality industries, the antimicrobial effects of these measures are typically short-lived. Therefore, there is a pressing need for creating surfaces, especially made of plastics, that have inherent antimicrobial properties (see US Patent Publication No. 2021/0054194).

Antimicrobial plastics are produced by incorporating antimicrobial additives into the plastic matrix. Antimicrobial additives are substances that possess the ability to kill or inhibit the growth of harmful microorganisms, such as bacteria, viruses, fungi, and algae. The choice of antimicrobial agent depends on the specific requirements of the application and may include metal-based additives (e.g., silver, copper, or zinc), organic compounds (e.g., quaternary ammonium compounds), or natural extracts. Antimicrobial additives can be incorporated into plastics at an early stage of processing, such as during compounding or masterbatch production, or at a later stage using surface coatings. Incorporating antimicrobial additives at early stage of production offers several advantages, including economic benefits, prolonged antimicrobial effectiveness, and enhanced durability of the antimicrobial properties.

Antimicrobial plastics play a significant role in a variety of industries, including healthcare, food and beverage, consumer goods, building and construction, and transportation. While antimicrobial additives offer substantial value in terms of sustained surface decontamination, their excessive use raises serious safety concerns for both human health and the environment. Additionally, excessive use of antimicrobial additives can significantly increase costs and potentially compromise the intrinsic physical properties of the plastic composite (see Dehghani et al, Food Packaging and Shelf Life 22, December 2019, doi.org/10.1016/j.fps1.2019.100391). Therefore, there is a continued need for innovations that minimize the relative quantities of antimicrobial additives while maintaining the required level of efficacy. One such approach involves facilitating surface migration of additives during the plastic processing stages.

### SUMMARY

Provided herein is a method for preparing a plastic masterbatch or compound, that includes (a) a dispersion step of suspending inorganic microparticles or nanoparticles in at least one low density solvent or low viscosity solvent and an optional dispersant and/or interface stabilizer, thereby producing a stock suspension, and wherein the suspended microparticles and/or nanoparticles remain homogeneously dispersed in the stock suspension, at least until the following step in the process; and (b) an extrusion step of combining the stock suspension with a polymer matrix in an extruder, wherein the viscosity of the stock suspension is less than that of the polymer matrix, thereby producing the plastic masterbatch or compound.

In particular embodiments of the described methods, the inorganic microparticles or nanoparticles are suspended in at least one low density solvent or low viscosity solvent by a homogenizer, disperser, ultrasound, sonication bath, or combination thereof.

In particular embodiments, at least one of the low density solvent or low viscosity solvent has a viscosity below 250 cP.

In some embodiments, the low density solvent or low viscosity solvent is a silicone oil such as but not limited to a silicone oil based on Polydimethylsiloxane (PDMS), methoxy-terminated silicone, ethoxy-terminated silicone, hydroxy-terminated silicone, siloxy-terminated silicone, amino-terminated silicone, carboxy-terminated silicone, epoxy-terminated silicone, vinyl-terminated silicone, paraffin, low molecular weight hydrocarbons, triglyceride, fatty acids ester, or any combination thereof.

In particular embodiments, the dispersion step includes suspending inorganic microparticles or nanoparticles in at least one low density solvent or low viscosity solvent as well as a dispersant and/or interface stabilizer. In such embodiments the dispersant is a phosphoric acid ester.

In some embodiments of the described methods, the inorganic microparticles or nanoparticles are metal, metal oxide, or ceramic.

In other particular embodiments, the inorganic microparticles or nanoparticles are antibacterial, antifungal, antiviral, photocatalytic, photoluminescent, gas sensing, catalytic, or any combination thereof.

In particular embodiments, the polymer is a polypropylene, polyethylene, polyolefin family, polystyrene, polyvinyl family, polyester family, polylactic acid, polycarbonate, polyethylene terephthalate glycol, polyurethane, polyamide, or acrylonitrile butadiene styrene.

In other particular embodiments, the amount of inorganic microparticles or nanoparticles in the plastic masterbatch or compound is lower or equal to 1% w/w.

Also provided is a method of producing a plastic product by providing a masterbatch and/or compound produced by the methods described herein and extruding, injection molding, blow molding, thermoforming, compression molding, rotational molding, 3D printing, or spinning the masterbatch or compound to form the plastic product.

### DETAILED DESCRIPTION

### Terms

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. It is further to be understood that all molecular weight or molecular mass values are approximate, and are provided for description. Although methods and materials similar or equivalent to those described herein can be used in the practice or testing of this disclosure, suitable methods and materials are described below. The term “comprises” means “includes.” The term “consists essentially of” or “consisting essentially of” indicates that the active ingredient or step of the described composition or method includes only the expressly recited ingredient or step. It is to be understood that compositions that “comprise” a given ingredient can also in other embodiments “consist essentially of” that ingredient. Similarly, methods that “comprise” a given set of steps can also in other embodiments “consist essentially of” the expressly indicated set of steps. The abbreviation, “e.g.,” is derived from the Latin exempli gratia, and is used herein to indicate a non-limiting example. Thus, the abbreviation “e.g.,” is synonymous with the term “for example.”

Antimicrobial agent: A compound that inhibits, prevents, or eradicates the growth, replication, spread or activity of a microorganism. In a particular embodiment, an antimicrobial agent is a described co-doped magnesium oxide nanocomposite. When used generally, an antimicrobial agent can inhibit, prevent, or eradicate the growth and spread of living microbes such as bacteria and fungi and/or non-living viral microbes. A microbe is inhibited when its presence or activity is decreased by at least 10%, at least 20%, at least 30%, at least 50%, at least 80%, at least 100% or at least 250% or more as compared to a microbe that has not been contacted with the compound. An agent that eradicates a microbe or prevents its growth is also known as a microbicidal agent.

Composite: A material composed of two or more constituent parts, which are generally structurally and physically distinct. A nanocomposite material is of a size in the nanometer (nm) range, typically 1 to 1000 nm.

Doped (metal oxide): A metal oxide compound into which impurities are intentionally introduced. A co-doped composite compound contains multiple impurities. In particular embodiments of the nanocomposites described herein magnesium oxide is co-doped with zinc and calcium.

Effective amount of a compound: A quantity of compound sufficient to achieve a desired effect. In a therapeutic context, a therapeutically effective amount of a compound is that amount to achieve a desired effect in a subject being treated. For example, the therapeutically effective amount of the described nanocomposites will be the amount necessary to provide antimicrobial effects when brought into contact with a wound or when coated on an inanimate surface.

Low viscosity solvent: A liquid solvent having a viscosity of no more than 250 cP, such as between 0.5-100 cP.

Microparticle: Particle having a diameter in the micron range, greater than 1 micrometer.

Nanoparticle: Particle having a diameter in the nanometer (nm) range, typically 1 to 1000 nm.

In case of conflict, the present specification, including explanations of terms, will control. In addition, all the materials, methods, and examples are illustrative and not intended to be limiting.

### Methods for Preparing Plastic Materials With Improved Surface Migration of Suspended Particles

Disclosed herein, is a process for manufacturing microparticle and/or nanoparticle-containing plastic materials having increased distribution of the particles at the surface of the material, and an enhanced ability to provide the particles at the surface of the material (i.e., enhance particle migration to the surface), and which reduces the particle material lost in the manufacturing process. Moreover, plastic materials produced by the described methods, and which contain antimicrobial micro/nanoparticle active agents, can provide strong antimicrobial functionality using significantly less antimicrobial micro/nanoparticle active agent than previously described manufacturing processes.

The described processes include a particle dispersion step and an extrusion step. The dispersion step includes suspending microparticles and/or nanoparticles in at least one low density solvent or low viscosity solvent optionally at least one dispersant and/or interface stabilizer (e.g. a surfactant). This mixture, resultant from the dispersion step, is referred to herein as a “stock suspension.” In the stock suspension, the suspended particles remain homogeneously dispersed prior to the extrusion step. It will be appreciated therefore that the time between the dispersion step and the extrusion step is sufficiently short so that the microparticles and/or nanoparticles remain homogeneously dispersed and suspended in the stock suspension. In addition, the overall viscosity and/or density of the stock suspension is less than that of the plastic polymer carrier that is selected for use in the extrusion step. Accordingly, it will be appreciated that the selection of low density solvent or low viscosity solvent will be dictated in part by its compatibility with the particles to be suspended. Likewise, the selection of the solvent and/or the plastic polymer carrier will depend on the viscosity or density of the solvent and/or polymer.

The extrusion step includes mixing the stock suspension with at least one plastic polymer carrier. The extrusion step can be carried out by any method known to the art, for example in a plastics extruder. In particular examples, the stock suspension and the polymer are combined prior to injection into the extruder. In other embodiments, the stock suspension and polymer are injected into the extruder by way of two separate channels that then are combined within the extruder.

Particular non-limiting examples of microparticles and nanoparticles for use in the described methods include metal, metal oxides or nanoceramics such as but not limited to Silver, Copper, TiO₂, ZnO, CuO/ZnO nanocomposites, MgO related nanocomposites, CaO, FeO or combinations thereof.

In particular embodiments, the nanoparticles are a metal oxide nanocomposite that has a chemical formula of CuO₍₁₋ₓ₎ZnOₓ, wherein X is the atomic ratio of zinc oxide impurities in the nanomaterial. In another particular embodiment, the nanoparticles are a metal oxide nanocomposite that is a co-doped magnesium oxide nanocomposite having the formula of (A_{X}B_{Y})Mg_{(1-Y)}—_{X}O, wherein X is the atomic ratio of metal A to the magnesium oxide, and Y is the atomic ratio of metal B to the magnesium oxide, and metal A is a transition metal selected from the group consisting of titanium, vanadium, manganese, iron, zirconium, niobium, silver, and zinc, and metal B is an alkali or alkaline earth metal selected from the group consisting of lithium, sodium, potassium, calcium, strontium, and barium. Illustrative methods of synthesizing metal oxide nanocomposites can be found in U.S. Pat. No. 10,995,011 and US Patent Publication No. 2022/0279794.

As described, the microparticles and/or nanoparticles are suspended in a low density solvent or low viscosity solvent, and optionally with a dispersant and/or interface stabilizer. The low density solvent or low viscosity solvent has a density below 250 cP, such as from about 0.5 cP to 100 cP. Particular non-limiting examples of low density solvent or low viscosity solvents that can be used for suspension of microparticles and/or nanoparticles in the described methods include silicone oils, mineral oils, aromatic or aliphatic hydrocarbon solvent mixtures, fatty acids or triglycerides or combinations thereof. Microparticles and/or nanoparticles are be suspended in a variety of solvents in the dispersion step such that the suspended particles are well dispersed throughout the solvent material and the overall density and/or viscosity of the stock suspension is less than that of the plastic carrier polymer to be used in the extrusion step.

In particular embodiments, the optional dispersant and/or interface stabilizer is combined with the microparticles and/or nanoparticles and the low density solvent or low viscosity solvent. Dispersants for use in such embodiments include, but are not limited to polymeric phosphoric acid esters, such as phosphoric acid ester alkylammonium salt, or chemically and functionally similar compounds (see for example U.S. Pat. No. 6,310,123).

The dispersion step can be carried out by homogenization dispersion or sonication of the microparticles and/or nanoparticles, low density solvent or low viscosity solvent, and dispersant, thereby producing a stock suspension.

After the dispersion step, the stock suspension is combined with a polymer matrix, for example in an polymer extruder, thereby producing a plastic masterbatch or compound. Any polymeric material used in the art of plastics manufacturing can be used in the methods described herein. Particular non-limiting examples of polymers for use in the described methods include a polypropylene, polyethylene, polyolefin family, polystyrene, polyvinyl family, polyester family, polylactic acid, polycarbonate, polyethylene terephthalate glycol, polyurethane, polyamide, or acrylonitrile butadiene styrene.

The extrusion step involves combining the stock suspension with the polymer. In particular embodiments, the stock suspension and the polymer are combined and then injected into an extruder. In other embodiments the stock suspension and the polymer are injected into an extruder through separate channels after which the materials are combined within the extruder.

As described the masterbatches and compounds produced by the described methods include microparticles and/or nanoparticles, a low density solvent or low viscosity solvent, and a polymer. The masterbatches and compounded materials produced by the described methods can include 80%-99%, 99%-99.9% w/w polymer, such as 80, 85, 90, 91, 92, 93, 94, 95, 96, 97, 98, and 99% and increments in between of the component polymer. In particular embodiments, the masterbatch and compounded materials can include 0.01%-10% w/w microparticles and/or nanoparticles, such as 0.01%-1%, 0.1, 0.2, 0.3, 0.4, 0.5, 0.6, 0.7, 0.7, 0.8, 0.9 and 1% w/w or increments in between of the microparticles and/or nanoparticles. In the described methods, the low density solvent or low viscosity solvent can be present in a concentration of 1-10%, such as 1, 2, 3, 4, 5, 6, 7, 8, 9, 10% or increments in between.

When combined in the extrusion step, the stock suspension and the polymer are combined in a ratio determined by the amount of polymer. For example, in particular embodiments, the masterbatch or compound includes 90% polymer. In such embodiments, it would include up to 10% stock suspension. Similarly in particular embodiments in which the polymer is present at a concentration of 95% w/w, the stock suspension would be present in a concentration of up to 5% w/w.

Following the extrusion step, the resultant polymeric masterbatch or compound can be further processed by any method known to the art to produce solid and fibrous polymeric materials. In particular embodiments, masterbatches and compounds produced by the methods described herein may be used to produce, for example, finished articles like plastics films and sheets, molded or injected products, fibers, 3D printing filaments, and textiles.

Articles produced by the further processing of masterbatches and compounds described herein will exhibit functionalities provided by the microparticles and/or nanoparticles contained within the articles. Moreover, the described methods will result in enhanced surface migration of the specific micro/nanomaterials such that their functionalities can be efficiently provided at lower concentrations than previously needed in such contexts. Particular non-limiting examples of such functionalities include antimicrobial, antiviral, photocatalytic, photoluminescent, gas sensing, catalytic, or combinations thereof. Such articles can have a wide variety of uses, such as but not limited to in the food and beverage industry, agriculture, plastics industry, water treatment, as a component of medical devices, textiles, and the like.

The following examples are provided to illustrate certain particular features and/or embodiments. These examples should not be construed to limit the disclosure to the particular features or embodiments described.

### Examples

### Example 1: CuO₍₁₋ₓ₎ZnOₓ Antibacterial Nanocomposite with LDPE

Masterbatch was produced using twin-screw extruder. The masterbatch was composed of 40% [w/w] CuO₍₁₋ₓ₎ZnOₓ antibacterial nanocomposite and 60% of low-density polyethylene (LDPE), where CuO₍₁₋ₓ₎ZnOₓ antibacterial nanocomposite was introduced to the process in powder form. Later the masterbatch was diluted in a blow film extruder to achieve an LDPE sheet containing 0, 2, 5, 10 & 20% [w/w] CuO₍₁₋ₓ₎ZnOₓ nanocomposite. All the sheets were tested for antibacterial activity, according to JIS 2801 (equivalent to ISO 22196:2011, available online at iso.org/obp/ui/#iso:std:iso:22196:ed-2:v1:en), which is used to determine antimicrobial efficacy for surfaces.

None of the samples showed any activity, except the sample which contained 20% CuO₍₁₋ₓ₎ZnOₓ nanocomposite, which showed 1.2 log reduction in bacterial growth.

### Example 2: CuO₍₁₋ₓ₎ZnOₓ antibacterial nanocomposite+Tegomer with polypropylene (PP)

A masterbatch was prepared using twin-screw extruder. The masterbatch was composed of 6.25% CuO₍₁₋ₓ₎ZnOₓ antibacterial nanocomposite powder and 93.75% Tegomer. Tegomer is a commercial additive made of PP and silicone oil (available for example from Evonik at corporate.evonik.com/en/sustainability/circular-plastics/get-to-know-our-product-range-176589.html).

The above-mentioned masterbatch was diluted in a blown film extruder with E50E polypropylene (PP) to final composition of 84% E50E PP, 15% Tegomer, and 1% CuO₍₁₋ₓ₎ZnOₓ antibacterial nanocomposite, and was processed into sheets.

The sample sheet was tested according to JIS 2801 as noted above, and displayed a 1.3 log reduction in microbial growth. Although this is the same result as the sample from Example 1, the sample in that experiment included 20 times more active material. Based on this result it can be concluded that the silicone compound helped migration of the CuO₍₁₋ₓ₎ZnOₓ nanocomposite to the surface of the plastic sheet.

However, silicone oil didn't help with the poor dispersion of the CuO₍₁₋ₓ₎ZnOₓ nanocomposite in the plastic material, as dark dots were still noticeable on the plastic sheet. Furthermore, it was detected that in the masterbatch/compound production process, there was a loss of active material of up to 30%.

### Example 3: Silicone Oil Suspension of CuO₍₁₋ₓ₎ZnOₓ Antibacterial Nanocomposite Compounded with LDPE

5% CuO₍₁₋ₓ₎ZnOₓ nanocomposite was sonicated in Silicone oil (Polydimethylsiloxane trimethylsiloxy terminated) for 2 minutes at 80% amplitude. The suspension was injected to the twin-screw extruder while LDPE 11 was fed through the feeder in mass ratio of 90:10, in favor of the LDPE. The final composition of the compound was 90% LDPE, 9.5% Si-oil, and 0.5% CuO₍₁₋ₓ₎ZnOₓ nanocomposite.

The compound was fed to the blown film extruder, without being diluted, for creation of sheets with the same composition of the compound. The sheets were tested according to JIS 2801 and displayed 4 log reduction in growth of S. aureus.

### Example 4: Silicone Oil Suspension of CuO₍₁₋ₓ₎ZnOₓ Antibacterial Nanocomposite Compounded with PP-T12 for Spinnability Test to be Use for Non-Woven Fabrics

In this example we repeated the experiment described in Example 3 but using PP-T12, a PP brand typically used in production of non-woven fabric. The compound produced by the described method was further processed in a standard spinning process into 40-50 μm wide fibers. Those produced fibers were tested for anti-bacterial activity as above, and showed 4 log reductions against E. coli and S. aureus.

### Example 5: Silicone Oil Suspension of CuO₍₁₋ₓ₎ZnOₓ Antibacterial Nanocomposite Using a Dispersant Compounded with PP-T12

5% CuO₍₁₋ₓ₎ZnOₓ nanocomposite was sonicated in Silicone oil (Polydimethylsiloxane trimethylsiloxy terminated) with the addition of 0.5% of a commercial polymeric phosphoric acid ester alkylammonium salt as dispersant for 2 minutes at 80% amplitude. The suspension was injected to the twin-screw extruder while in a separate channel, PP-T12 was fed through the feeder in mass ratio of 90:10, in favor of the PP-T12. The final composition of the compound was 90% PP-T12, 9.5% Silicone oil & 0.5% CuO₍₁₋ₓ₎ZnOₓ nanocomposite.

The compound was fed to the blown film extruder, without being diluted, for creation of sheets with the same composition of the compound. The sheets were tested according to JIS 2801 and showed a 4 log reduction in growth of S. aureus.

### Example 6: Effect of Nanomaterial Concentration on Antimicrobial Activity of Compounded Nanomaterial—Polypropylene Composite

This example tested the effects of varying the concentration of CuO₍₁₋ₓ₎ZnOₓ nanocomposite on the antimicrobial activity of plastic compositions produced by the described methods. CuO₍₁₋ₓ₎ZnOₓ nanocomposite was sonicated in Silicone oil for 2 minutes at 80% amplitude at varying concentrations to produce the final theoretical nanocomposite concentrations indicated in Table 1, below. The sonicated oil/nanocomposite stock suspension was then injected to a twin-screw extruder while in a separate channel, either PP-E50E or PP-T12 was fed through the feeder in mass ratio of 90:10, in favor of the polypropylene. Compounded PP-E50E/stock suspension was then fed to the blown film extruder, without being diluted, for creation of sheets. Compounded PP-T12/stock suspension was processed in a standard spinning process into 40-50 μm wide fibers. Antibacterial activity against Pseudomonas aeruginosa was tested as above, and the results are shown in Table 1, which also shows the concentration of the nanomaterial in the compounded materials as determined by inductively coupled plasma mass spectroscopy (ICP).

TABLE 1
CuO₍₁₋ₓ₎ZnOₓ Concentration dependent antimicrobial
activity of PP films and fibers.

| | | Conc. | Anti-bacterial activity | |
|---|---|---|---|---|
| Sample | Theoretical | By | [Log reduction] | |
| No. | Conc. [%] | ICP [%] | Films | Fibers |
| 103-01-31.2 | 0.3 | 0.44 | >2.9 log | |
| | | | (TK) | |
| 103-01-31.3 | 0.5 | 0.56 | >2.9 log | |
| | | | (TK) | |
| 103-01-31.4 | 0.3 | 0.29 | >2.9 log | |
| | | | (TK) | |
| 103-01-31.5 | 0.8 | 0.47 | >2.9 log | |
| | | | (TK) | |
| 103-01-31.8 | 0.04 | 0.02 | | 3.1 |
| 103-01-31.9 | 0.05 | 0.05 | | 3.1 |

As shown in Table 1, little to no nanocomposite was lost in the compounding process. Additionally, all materials tested demonstrated robust antimicrobial activity, even at the lowest concentrations tested.

### Example 7: Effect of Silicone Oil Concentration on the Melt Flow Index of Compounded Nanomaterial—Polypropylene Composite

This example tested the effects of varying the concentration of silicone oil on the melt flow index of plastic compositions produced by the described methods. CuO₍₁₋ₓ₎ZnOₓ nanocomposite was sonicated in 3, 5, or 8% silicone oil for 2 minutes at 80% amplitude. The sonicated oil/nanocomposite stock suspension was then injected to a twin-screw extruder while in a separate channel, either PP-E50E or PP-T12 was fed through the feeder in varying mass ratios in favor of the polypropylene (see Table 2). Melt flow index was determined according to standard methodology at 230° ° C. The results of this assay are shown in Table 2.

TABLE 2
Effect of Silicone oil concentration on the Melt
Flow Index (MFI) of the PP compounds

| | | [%] Silicone oil containing | | | MFI |
|---|---|---|---|---|---|
| | PP | 3% | 5% | 8% | [230° C., |
| Compound | [%] | CuO/ZnO | CuO/ZnO | CuO/ZnO | 2.16 Kg] |
| E50E | 100 | — | — | — | 1.8 |
| 103-01-31.2 | 90 | 10 | — | — | 3.2 |
| 103-01-31.3 | 90 | — | 10 | — | 3.1 |
| 103-01-31.4 | 94 | — | 6 | — | 2.8 |
| 103-01-31.5 | 90 | — | — | 10 | 2.9 |
| T12 | 100 | — | — | — | 26 |
| 103-01-31.8 | 99.5 | — | — | 0.5 | 33 |
| 103-01-31.9 | 99 | — | 1 | — | 33 |

shown on Table 2, melt flow index increases with the amount of PP in the final masterbatch or compound.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for preparing a plastic masterbatch or compound, comprising:
a dispersion step comprising suspending inorganic microparticles and/or nanoparticles in at least one low density solvent or low viscosity solvent and an optional dispersant and/or interface stabilizer, thereby producing a stock suspension, wherein the suspended microparticles and/or nanoparticles remain homogeneously dispersed in the stock suspension; and
an extrusion step comprising combining the stock suspension with a polymer matrix in an extruder, wherein the viscosity of the stock suspension is less than that of the polymer matrix,
thereby producing the plastic masterbatch or compound.

2. The method of claim 1, wherein the inorganic microparticles or nanoparticles are suspended in the at least one low density solvent or low viscosity solvent by a homogenizer, disperser, ultrasound, sonication bath, or combination thereof.

3. The method of claim 1, wherein at least one of the low density solvent or low viscosity solvent has a viscosity below 250 cP.

4. The method of claim 1, wherein the low density solvent or low viscosity solvent is silicone oil based on Polydimethylsiloxane (PDMS), methoxy-terminated silicone, ethoxy-terminated silicone, hydroxy-terminated silicone, siloxy-terminated silicone, amino-terminated silicone, carboxy-terminated silicone, epoxy-terminated silicone, vinyl-terminated silicone, paraffin, low molecular weight hydrocarbons, triglyceride, fatty acids ester.

5. The method of claim 1, wherein the dispersion step comprises suspending inorganic microparticles or nanoparticles in at least one low density solvent or low viscosity solvent and a dispersant and/or interface stabilizer.

6. The method of claim 1, wherein the dispersion step comprises suspending inorganic microparticles or nanoparticles in at least one low density solvent or low viscosity solvent and a dispersant and wherein the dispersant is a phosphoric acid ester.

7. The method of claim 1, wherein the inorganic microparticles or nanoparticles are metal, metal oxide, or ceramic.

8. The method of claim 1, wherein the inorganic microparticles or nanoparticles are antibacterial, antifungal, antiviral, photocatalytic, photoluminescent, gas sensing, catalytic, or any combination thereof.

9. The method of claim 1, wherein the polymer is a polypropylene, polyethylene, polyolefin family, polystyrene, polyvinyl family, polyester family, polylactic acid, polycarbonate, polyethylene terephthalate glycol, polyurethane, polyamide, or acrylonitrile butadiene styrene.

10. The method of claim 1, wherein the amount of inorganic microparticles or nanoparticles in the plastic masterbatch or compound is lower or equal to 1% w/w.

11. A method of producing a plastic product comprising;
providing a masterbatch and/or compound produced by the method of any one of the preceding claims, and
forming the plastic product through extruding, injection molding, blow molding, thermoforming, compression molding, rotational molding, 3D printing, or spinning the masterbatch and/or compound.
